(19) United States
(12) Patent Application Publication
(10) Pub. No.: US 2012/0130910 A1
(43) Pub. Date: May 24, 2012

(54) CUSTOMER SUPPORT FLOW

(75) Inventor: Mustafa Omar Al-Alami, San Francisco, CA (US)

(73) Assignee: salesforce.com, inc., San Francisco, CA (US)

(21) Appl. No.: 13/093,478

(22) Filed: Apr. 25, 2011

Related U.S. Application Data
(60) Provisional application No. 61/415,784, filed on Nov. 19, 2010.

(51) Int. Cl. G06Q 10/00

(52) U.S. Cl. 705/304

(57) ABSTRACT

A customer support flow system and method is described. In one example, a method includes, receiving an inquiry from a user, forwarding the inquiry to a public user group. Forwarding the inquiry to a customer support agent, applying the inquiry to previously received comments, receiving a comment to the inquiry from at least one of the public user group, the customer support agent, and the applying of the inquiry, and displaying the received comments to the user on a single display.

### CLAIM OF PRIORITY

This application claims the benefit of U.S. Provisional Patent Application No. 61/415,784 entitled Methods and Systems for a Customer Support Flow, by Mustafa Al-Alami, filed Nov. 19, 2010 (Attorney Docket No. 489PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to providing customer support from multiple different sources in a single system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A product or service user or customer is typically confronted with many different options when seeking information and support about the product or service. A call to the provider may provide useful results, but it may not. Some may prefer to perform a web search which may or may not produce useful results. In addition, the results from such a search may provide results from untrustworthy sources. Similarly, a visit to the support website offered by the maker or distributor of a product may not provide any results to a current problem. The many different sources of information and the differences in the quality and quantity of support information provided may reduce the satisfaction that a customer may feel about the product or service.

### BRIEF SUMMARY

In accordance with embodiments, there are provided mechanisms and methods for a customer support flow. These mechanisms and methods for customer support can enable embodiments to provide more reliable and faster provision of support to customers and users of both products and services.

A customer support flow system and method is described. In one example, a method includes, receiving an inquiry from a user, forwarding the inquiry to a public user group. forwarding the inquiry to a customer support agent, applying the inquiry to previously received comments, receiving a comment to the inquiry from at least one of the public user group, the customer support agent, and the applying of the inquiry, and displaying the received comments to the user on a single display.

While the present invention is described with reference to an embodiment in which techniques for customer support are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like, or on web server architectures without departing from the scope of the embodiments claimed.

Any of the embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 is an operational flow diagram illustrating a high level overview of different workflows for providing customer support.

FIGS. 2A-2E illustrate block diagrams of customer support web pages for supporting the present invention in an embodiment.

FIG. 3 illustrates a diagram of an index to a web site that provides product information and support for supporting the present invention in an embodiment.

FIGS. 4A-I illustrate block diagrams of customer support web pages for supporting the present invention in an embodiment.

FIGS. 5A-5E illustrate block diagrams of arranging and displaying content on customer support web pages for supporting the present invention in an embodiment.

FIG. 6 illustrates a block diagram of an example of an environment wherein an on-demand database service might be used;

FIG. 7 illustrates a block diagram of an embodiment of elements of FIG. 6 and various possible interconnections between these elements;

FIG. 8 is an operational flow diagram illustrating a high level overview of techniques for performing the present invention in an embodiment; and

FIG. 9 is an operational flow diagram illustrating operations that may be performed according to the present invention in an embodiment.

### DETAILED DESCRIPTION

Systems and methods are provided for a customer support flow. These systems and methods are particularly valuable in the context of supporting products and services for which there are different sources of information available. These systems and methods may be provided using a multi-tenant database, but are not so limited.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for a customer support flow will be described with reference to example embodiments. In one implementation, a customer support system integrates public community answers, private case interaction, and company knowledge into one flow experience. In one embodiment, the system can be packaged and sold as one application that a company can customize and deploy to meet customer support needs. A customer support system can be designed to create a portal for a user to have his needs met. For example, the system may include ask and search interactions. It may include abilities to ask experts, seek customer support, and more.

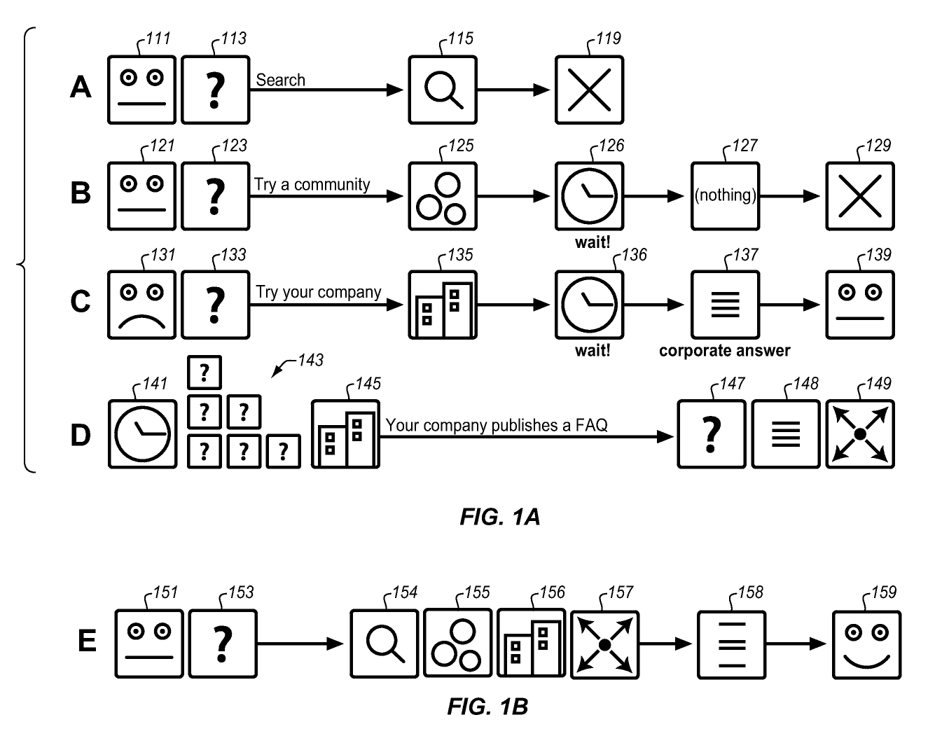

Examples of customer support sites and handling user questions are shown for example in FIG. 1. FIG. 1 shows a variety of different process flows for obtaining information about a product or service. In the example of FIG. 1 a customer has purchased a product or service and has a problem with a product or service. In Line or Process Flow A, the customer 111 formulates a query at 113. The query is submitted as a search to a search engine 115 and the search engine provides an answer. In some cases, this answer may be no answer 119 as shown in FIG. 1. In the case of no answer, the customer is frustrated and dissatisfied with the customer service.

In Process Flow B, the customer 121 formulates a question or query 123 and this question is applied to a community 125. The community may be a group of expert users, a discussion group, a user group, or any other type of group or community. After presenting the question to the community at 125, the customer will wait at 126. On some occasions, the customer may receive an answer to the query which solves the problem or in other cases as shown in FIG. 1 line B, the customer receives no answer at 127. At 129, no solution is received for the question.

Having obtained no successful resolution at 119 and 129, the customer may turn to the company that produces, maintains, or distributes the product. Alternatively, the customer may go to the company first. In Process Flow C, the customer 131 has become dissatisfied after having receiving no answers. The customer formulates a query 133 and applies that query to the company 135. The customer then waits at 136 for an answer and, at 137, the customer receives some answer from the company. At 139, the customer has received some level of satisfaction and now feels better about the company or the product than before.

In Process Flow D, the company takes some time at 141 and collects many different questions and queries 143 from one or more different sources. The company at 145 can then formulate and put together an FAQ (Frequently Asked Questions) 147. The FAQ provides a list of common or important questions selected by the company. The answers for these questions are compiled and are provided at 148. At 149, these are published to a website as a FAQ system.

Line E provides an alternative process flow. This process flow can serve as an alternative to lines A, B, C, and D and provide both better support and higher convenience. The customer 151 formulates a query or question 153 which is simultaneously submitted to a search engine 154, a community 155, the company 156, and the FAQ 157. All of the answers from these are collected and combined at 158 to present a number of different possible answers at 158. As seen at 159 this may result in a satisfied customer.

The question at 113, 123, 133, or 153 may be a service request, a repair request, a user instruction request, or some question about features or some operation of the product. In the Example of Line E, a single user or owner request is applied simultaneously to different possible sources of answers. This may result in a question being answered more quickly. With a single flow from the user to many different possible sources of answers, the customer is provided with one place to ask the customer service department of the company as well as various communities of others. The one process flow to get answers provides alternative answers and it may provide answers more quickly.

For the company, the single flow may reduce the cost of supporting products and services. It may automatically create a base of shared knowledge between users, fans, support groups, and the company. It may also provide a process for sales agents and service agents to engage in a customer community. This in many cases may result in happier customers.

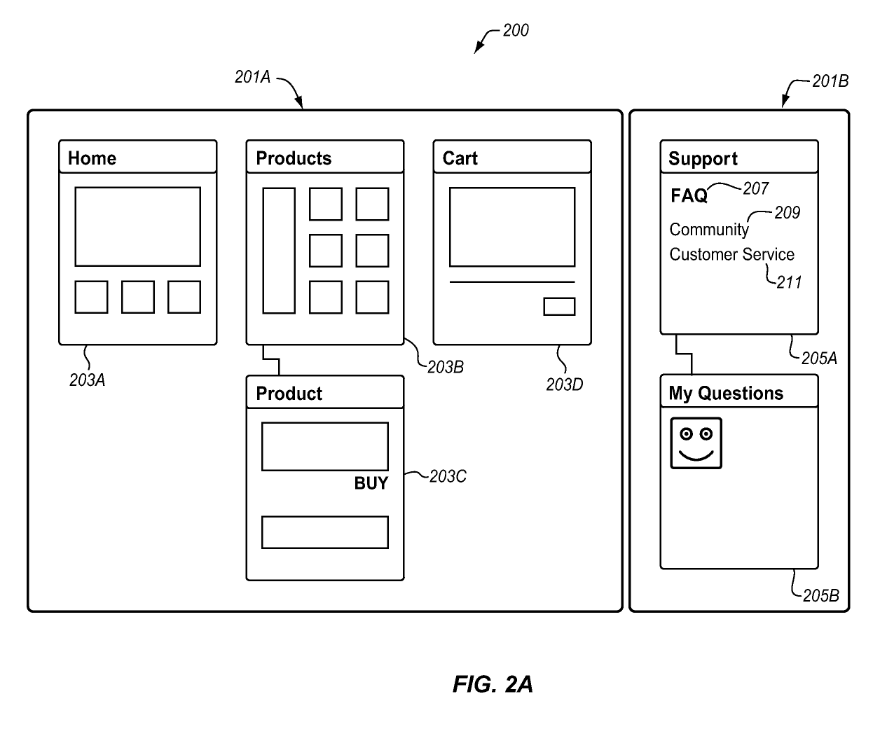

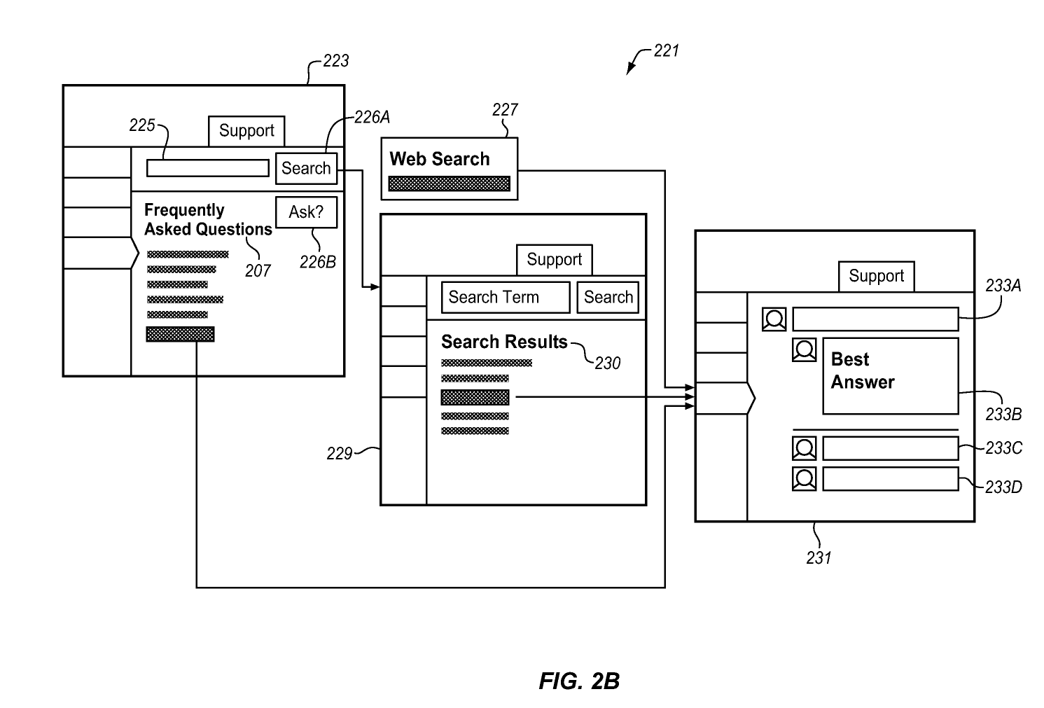

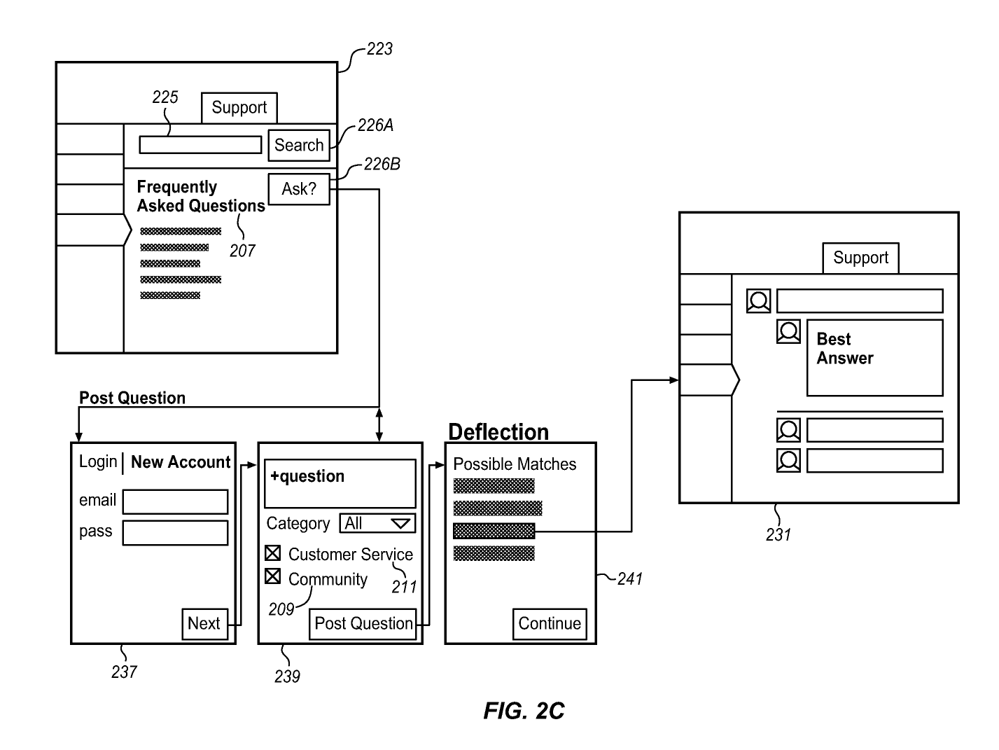

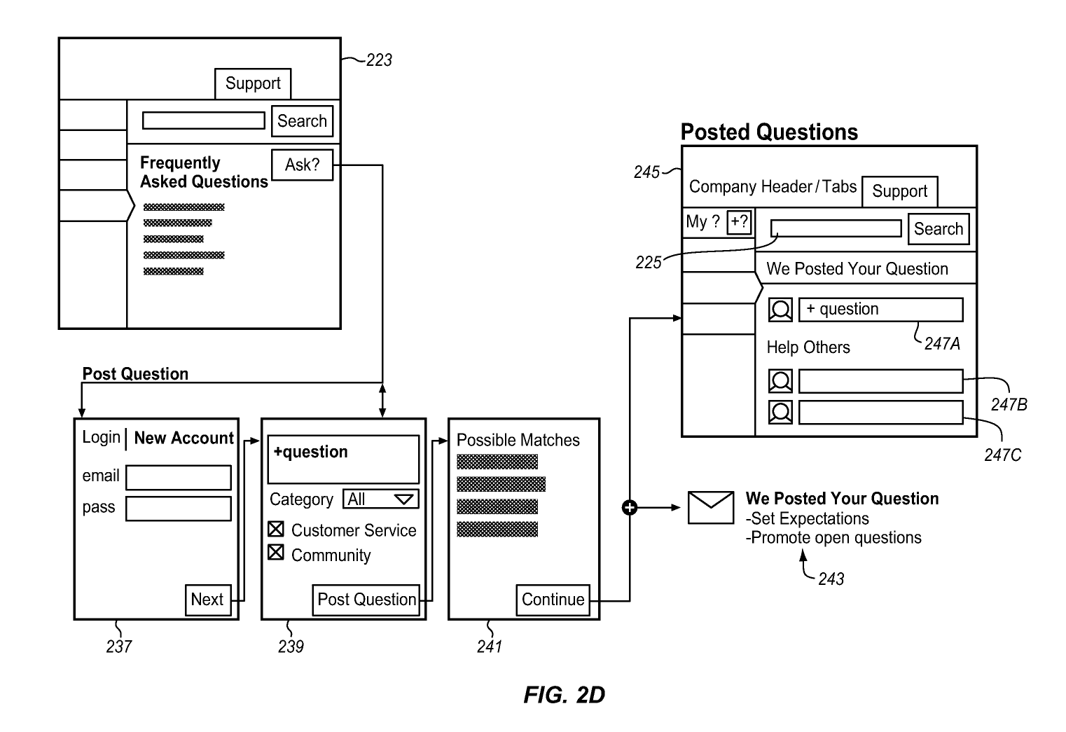

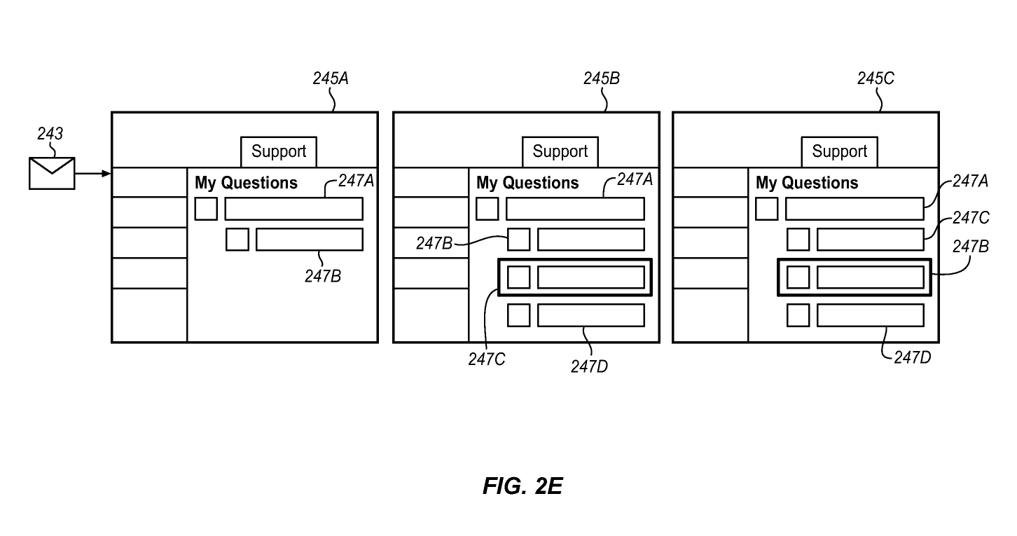

Referring to FIG. 2A, a company has a web site 200 with a product section 201A and a support section 201B. While the present example is described in the context of products, the same approaches may also be applied to services. Accordingly each reference to products should be understood as applicable also to services. The product section 201A of the web site can have a variety of areas, links to other pages, and links to micro sites. For example, there may be a home section 203A with references to support, dealer, distributor, developer, vendor, etc. log in, products, services, and special customer areas. There may be a special product section 203B with a link to special pages 203C with additional details about a product and there may be a shopping or purchasing section 203D with a shopping cart and financial transaction areas. In addition, in a support section 201B, the company may offer an FAQ 207 to help with immediate questions. There may be a support community 209 and there may be direct connections to contact customer service representatives 211.

FIG. 2A shows a support section of the web site with a main introductory page 205A and then a second page or section 205B connected or linked to the main section for specific individual customer questions and needs. The boxes of FIG. 2A can be understood as each representing a single page or a group of linked pages. Alternatively, each box may represent a different micro site. The pages may be hosted on one or more different or redundant servers and linked with hyperlinks or other means to allow a user to easily navigate through the site. In one example, the product area 201A can be hosted by the company, while the support area 201B can be hosted and maintained by a service provider. However, the particular entity to host, maintain and monitor the various pages and functions of the site may be adapted to suit any particular implementation.

In FIG. 2B the support section is expanded to show an example of how support can be provided for particular questions that a customer, shopper, or user may want to pose. The support question section, which may correspond to either the general support introductory page 205A or a more specific questions page 205B, is shown as a first questions page 223. This page may have a question box 225 with buttons to search or ask a question. There may be a reference to the FAQ 207 with a list of questions that are frequently asked. This allows the user to go directly to an answer, if a question in the FAQ is similar to the one that the user was going to pose.

Tabs along the left margin of the questions page may allow the user to select various functions on the support page. A user can type a question in the questions box 225. Upon pressing the ask key 226B, this question may be directed or sent directly to a company representative. Upon pressing a search key 226A it may be sent to a search engine that will search the company website, a support website, a community website, other websites, or a combination of websites for an answer.

As shown in FIG. 2B. the search button 226A provides an input into a search engine 229 to develop a set of search results 230 that are shown to the user. The user can then select any one of the results. As shown, the user can select the third result and this sends the user's search to an answer page 231 in which a set of answers are provided. The answer that the user has selected is shown first at 233A and a set of other answers are shown for comparison at 233B, 233C and 233D. The user can then also select which of the answers he considers best and designate that. In the example of FIG. 2B, the second answer 233B has been selected as the best answer. Alternatively, the best answer may be an answer that has been determined by the company to be the best answer and this is shown next to the user's select search result to help the user to find what may perhaps be a better answer than the one that the user selected.

As shown in FIG. 2B there may be multiple paths to the answer page 231. For example, from the original query page 223, a user might select one question from the frequently asked questions 207 and this may lead directly to the answer page 231 in which the answer to the selected question is shown together with other related answers. Alternatively a user might go to the answer page 231 directly from a web search 227 using any of a variety of web search engines. The web search engine may find an answer on the company's web site and the web search 227 may then lead the user directly to an answer page.

FIG. 2C shows an alternative additional feature that may be provided by the company website. In FIG. 2C, the same query page 223 is provided with a search box 225 for typing in a search, a search button 226A, and an ask button 226B. In this example, the user has typed in a query and then selected the ask button 226B. This query then is deflected to a special deflection section. In one example, by posting a question directly to the company using the ask button, the user is directed to a log in screen 237. The log in screen asks for an email or user ID and password or a new account registration if the user does not yet have an account. Upon entering the log in credentials, the user can be invited to determine how his question will be handled in an options box 239. In the example of FIG. 2C, the options box allows the user to determine whether the question should be sent to a customer service representative 211 or a user community 209 or both.

Upon making this kind of selection, the user can select to post the question and then a set of possible matches are shown in a box 241. As in the example of FIG. 2B, the user can then select one of the possible matches and is then sent to an answer page 231 in which one or more answers are shown and again, as in the example of FIG. 2B, the best answer is highlighted. Alternatively, from the query page 223 when the user selects the ask button, the question may be sent directly to the options box 239 to allow the user to select how that query is to be handled. As a further alternative, either the processing of FIG. 2B with a results page may be used for all queries or the deflection boxes of FIG. 2C may be used for all queries.

In FIG. 2D an alternative to the example of FIG. 2C is shown. The same query page 223 and the same deflection boxes 237, 239 and 241 are shown. However, when the possible matches are provided, the user can continue into a page 245 at which questions are posted. In the previous examples, the user was immediately provided with matching answers. However, in some cases there may be no matching answer and it remains for the community or the company representative to provide an answer to the query. In this case, the user may be required to wait until an answer is created. As a result, in FIG. 2D the user is presented with possible matches 241, none of which are satisfactory.

The user then continues from the possible answers of box 241 or, alternatively, as shown in FIG. 2B, the user can continue from the results page 229. The question can then be posted. The user can be informed at box 243 if the question has been posted and be given a warning about an amount of time it may take to receive an answer. Box 243 may also include a promotion for open questions to encourage users to post questions to the community. This encourages open questions, supporting the user community. The user community can then be hosted and developed for user enthusiasm and help in resolving questions. This adds value to the company.

Page 245 is a posted questions page. This page includes a place where a new question can be added at 225. The posted question can be shown at 247A and other questions can also be provided at 247B, 247C. These additional questions allow the user to provide answers for the benefit of others. If the user has additional knowledge about the product, then he can answer these other questions from other users. The user can also see what kinds of questions other people are asking.

FIG. 2E shows how a user with several questions can process and manage his own questions. From the question notification 243, which may be an e-mail, as indicated, or any other type of electronic indication. The user is notified that a question has been posted. Alternatively the user can log in to check the status of his question and then find that there is a status update. The user can be sent from the notification 243 to a posted questions page 245A where multiple questions are shown. Additional question pages 245B, 245C show further questions.

In the first questions page, the user can see his question 247A and an answer 247B. Any of the types of questions and answers described above may be presented. In addition, the left side of the page may present selection and sorting options, as described below. In the next page 245B, the user can be presented with additional answers 247B, 247C, 247D to the question. The number of answers can be controlled in part using the selection tabs on the left of the page or by selecting different question that have received more or fewer answers. The user has selected the second answer 247B and it is shown as highlighted. In the third page 245C, the user has moved the second answer 247B up one place so that it is now the top answer. These pages show one example of how a user can indicate which answers are his favorite answers.

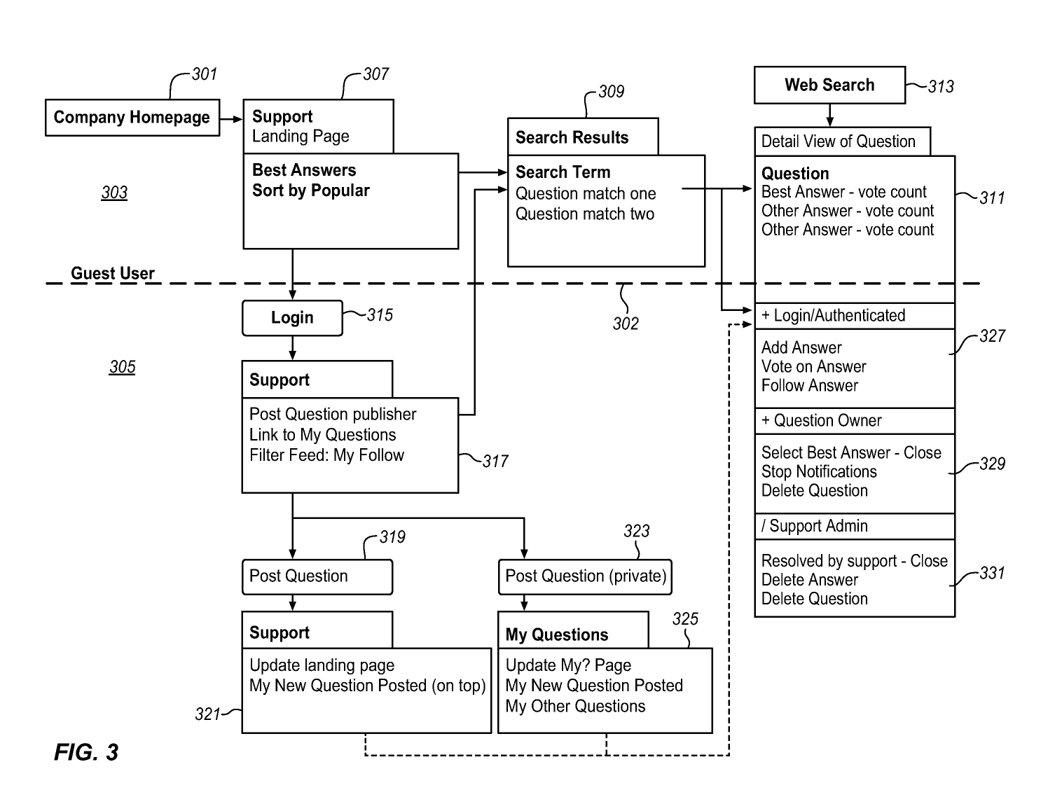

FIG. 3 shows an index to a company website to illustrate two different possible domains 303, 305. Additional and different domains may also be included, depending on the circumstances. In the upper, open domain, 303, a company website may have a home page 301 which can lead to a support section 307. The homepage may also lead to product, distributor, and other sections (not shown) as well. As mentioned above, the support section may present multiple answers to various questions which can be sorted by their popularity, by their importance, or by any other criteria that the company or site administrator may wish to use. The support page 307 can lead to a search page 309.

In the search page, a user may enter search terms. In the illustrated example, the user is shown other similar questions. This allows the user to select one of the similar questions instead of the one that the user entered. These pre-existing questions may already have answers, so that by selecting a similar prior question, the user receives faster service. As shown and described below, by matching the user's questions to other previously asked questions, a user can select a previously asked question that is directed to the same problem and find a better answer that has already been provided. This allows the user to have an immediate answer to an answer to a question rather than waiting for an answer to a slightly different question which is directed to the same problem.

The search terms page 309 then leads the user to an answer page 311. As shown in FIG. 3, the answer page may also be accessed through a web search page 313. In the answers page, there may be a detailed view of the particular question and then there may be a variety of different answers to that question which can be ranked or sorted either by the company, by the user, by the user community, or any one or more of these groups or other groups. The company home page, support page, search results page and detailed answers pages 301, 307, 309 and 311 belong to a general domain accessible to anyone.

Below a demarcation 302 of FIG. 3 is the second restricted domain 305 which is accessible only to those who have logged in or registered and then been granted access. From the support page 307, a user may log in 315 to obtain access to this second, privileged domain. This leads to a separate support page 317 which offers questions posting, links to previously asked questions, links to previously received answers, and a variety of other additional features that a user may desire to use to follow his problem. From this more detailed question page 317, a user may post new questions 319, 323. In this example, the user can indicate whether a question is to be posted to a community at 319 or whether the question may be a private question 323 which is not shown publicly. Alternatively, the question may be posted to a community or only directed to company representatives.

If a general question is posted 319 in the privileged domain, then the user may be directed to a support page 321 which shows the user's new question in a general open area. If the posted question is private 323 then a similar page 325 can be provided which allows only for private answers directly with the company. As illustrated, these support pages 323 and 325 for the authenticated, logged in user do not show in the open posted question and answer pages 309 and 311. Alternatively, these pages may lead directly to answer pages in the privileged domain 305.

As another alternative, these private and privileged answer pages 321-325 may lead directly into a special questions posted area within the privileged domain 305. In the posted questions area, FIG. 3 also shows, within the privileged domain 305, an area 327 for users to add answers, vote on and answer questions, and follow questions. In the illustrated example, this area is limited only to authenticated or logged in users. In another area 329, authenticated, logged in users may select answers, provide notifications, and manage questions to other users. Questions may be added or deleted. Owners of questions may manage their questions within these support areas. In another area 331, a site administrator may manage the site to delete answers, to delete questions, to resolve problems, and to respond directly to users.

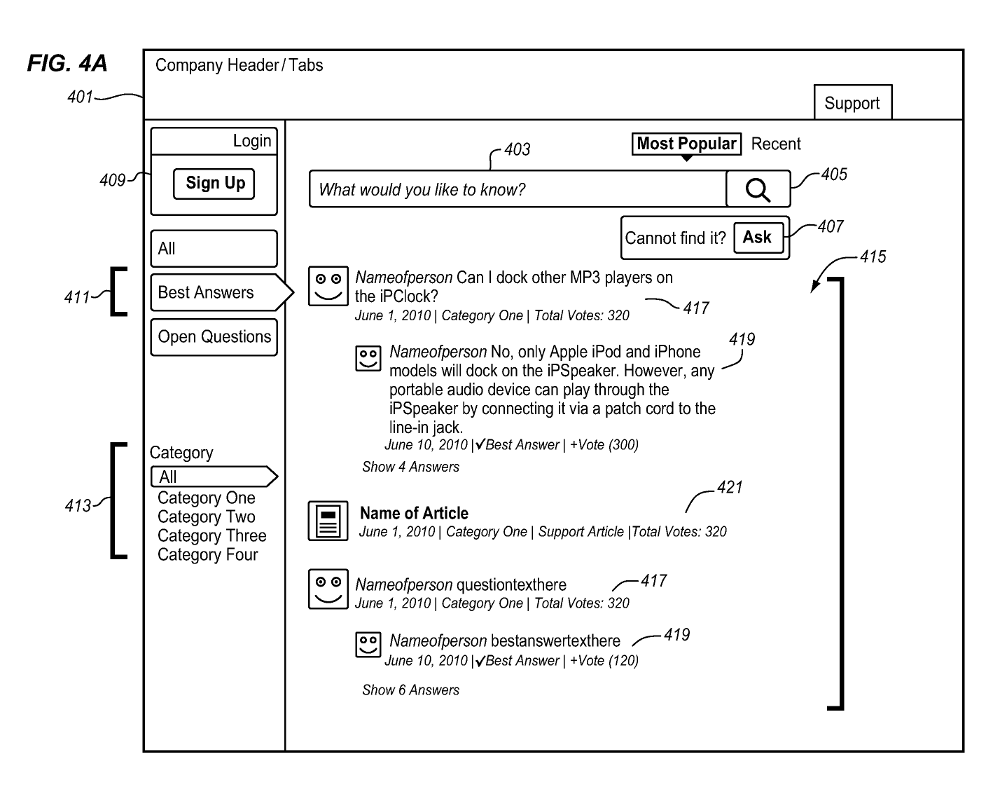

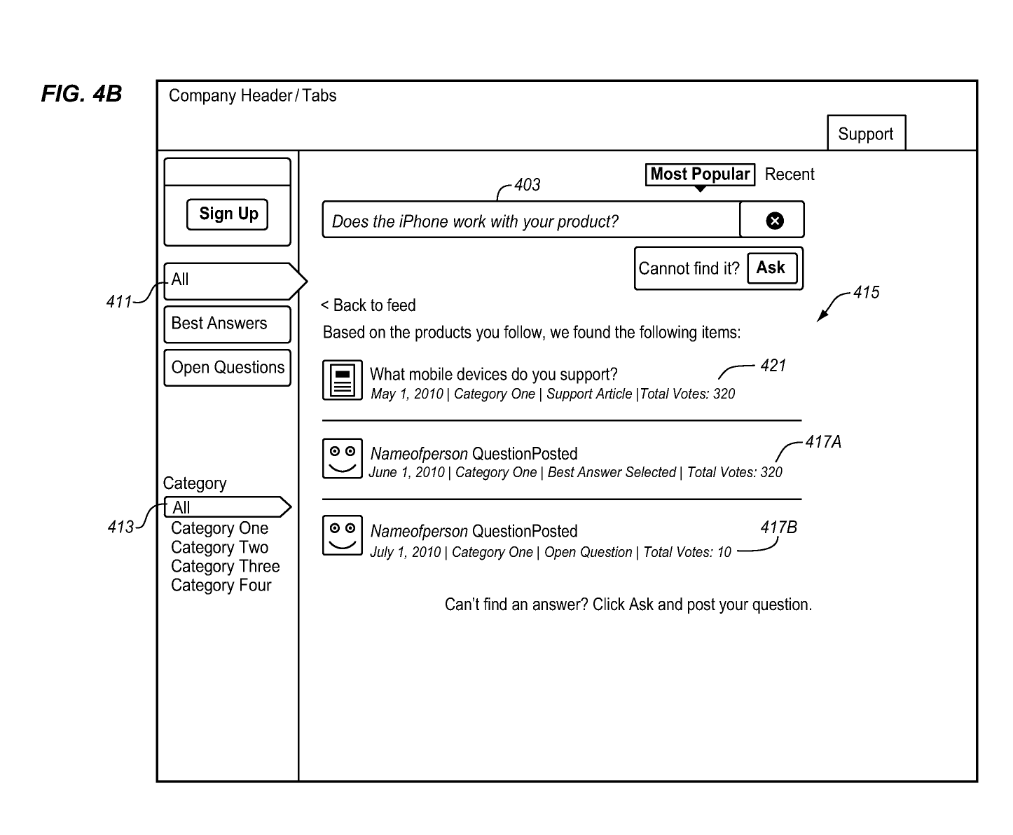

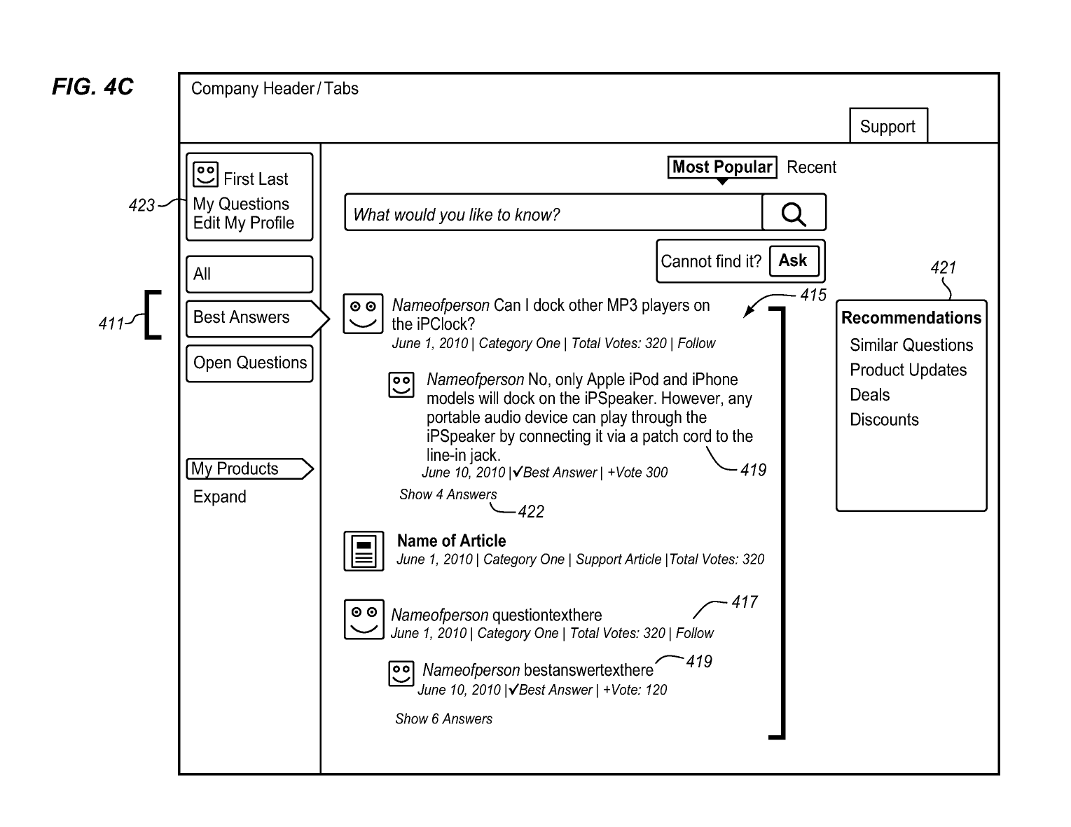

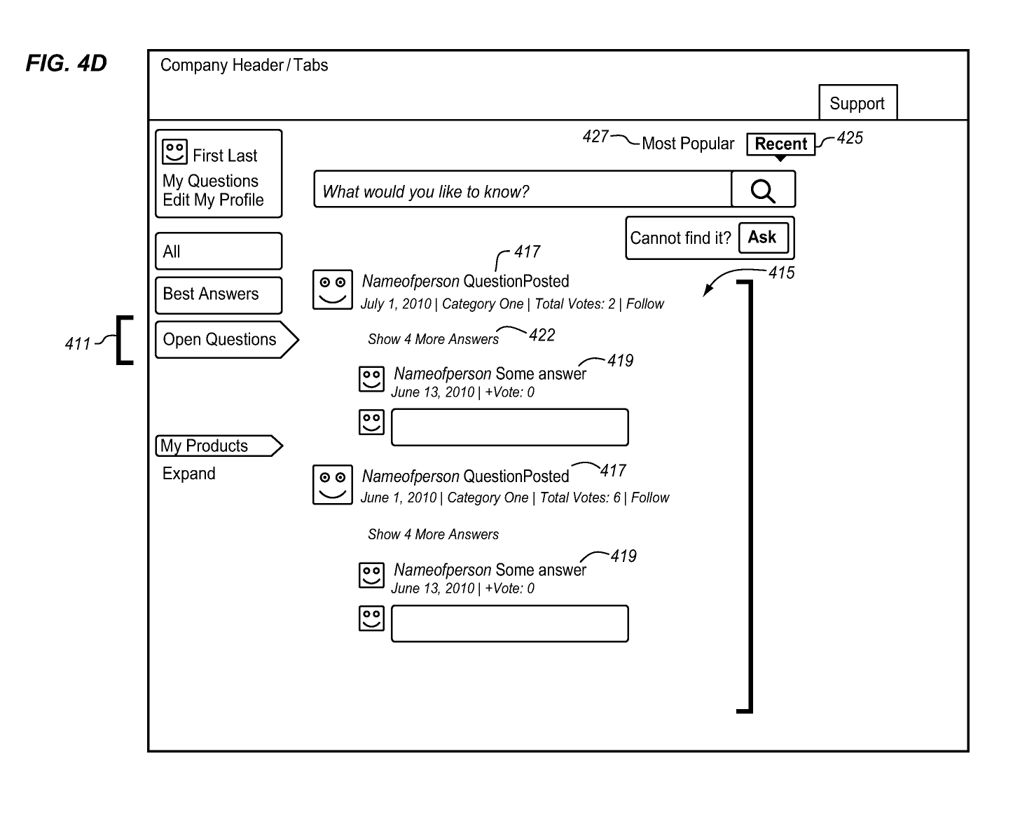

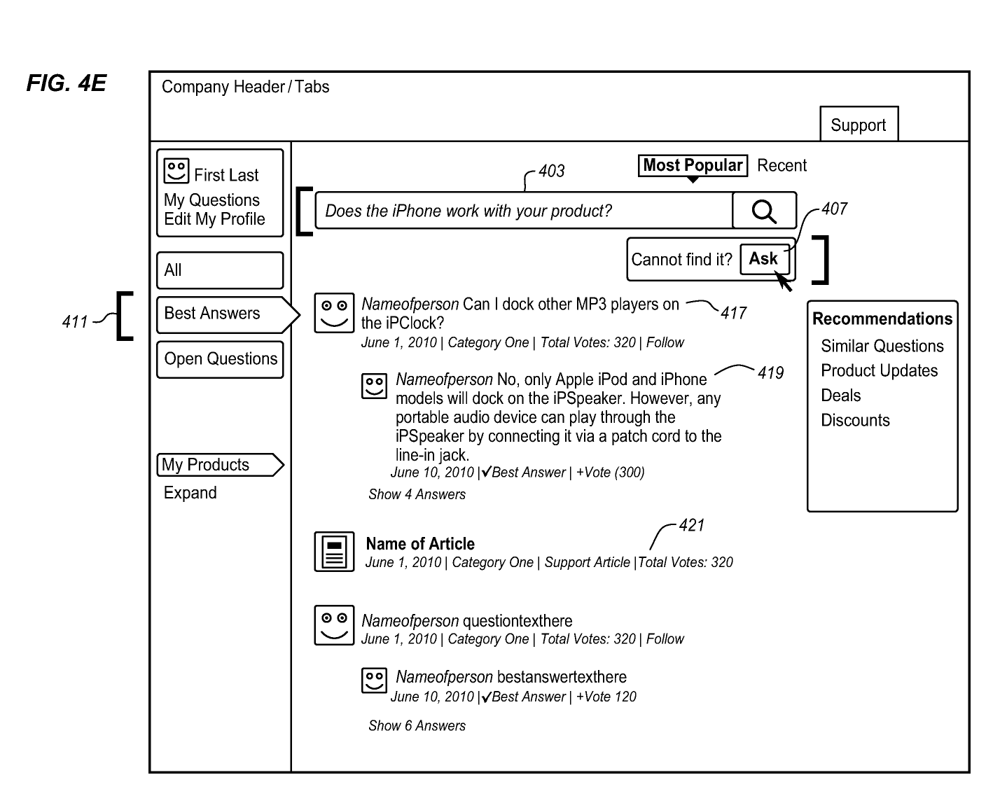

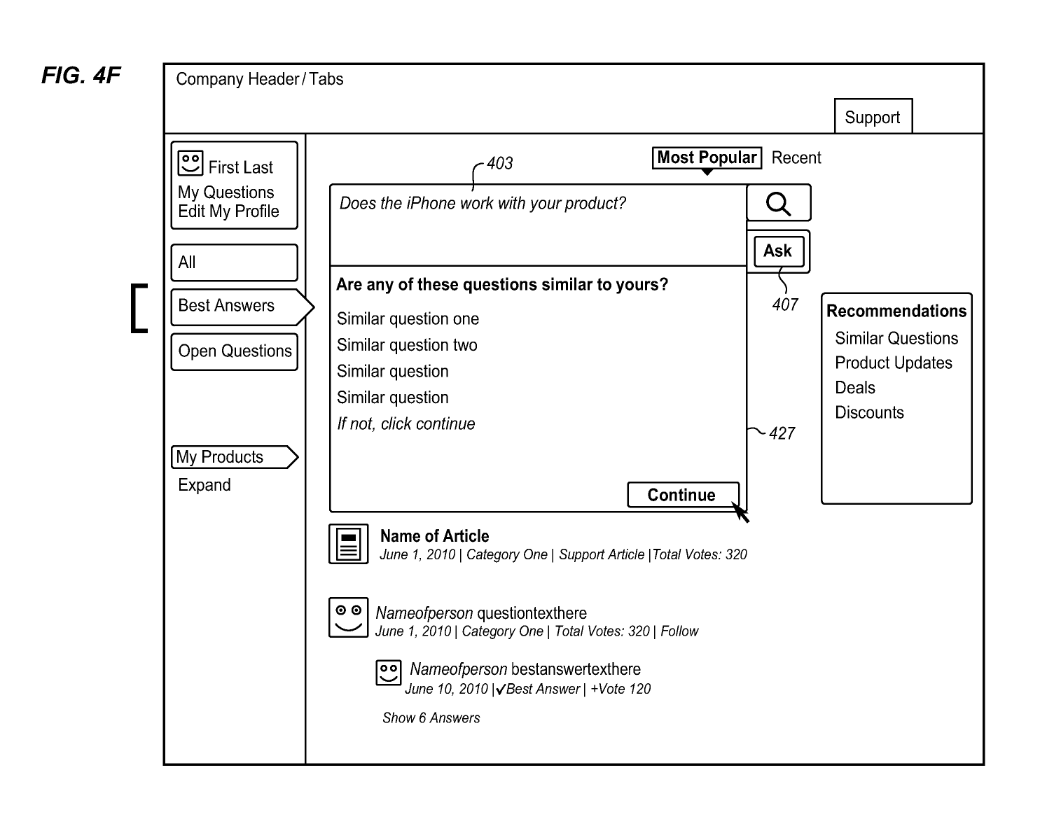

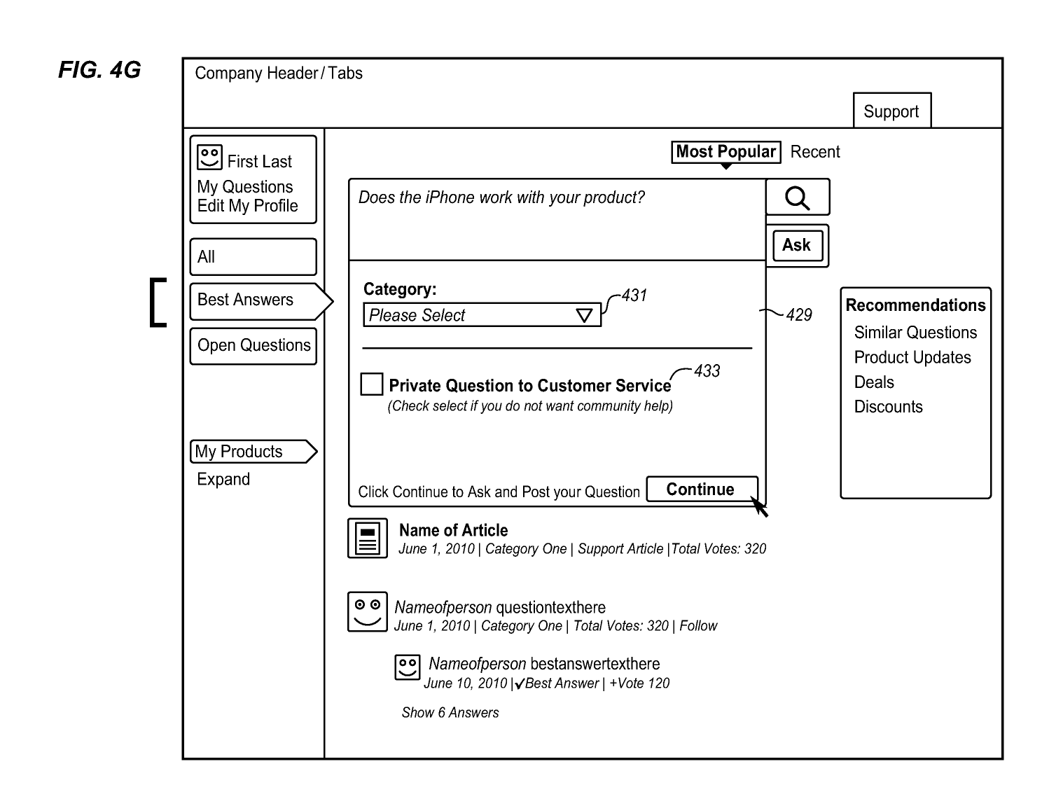

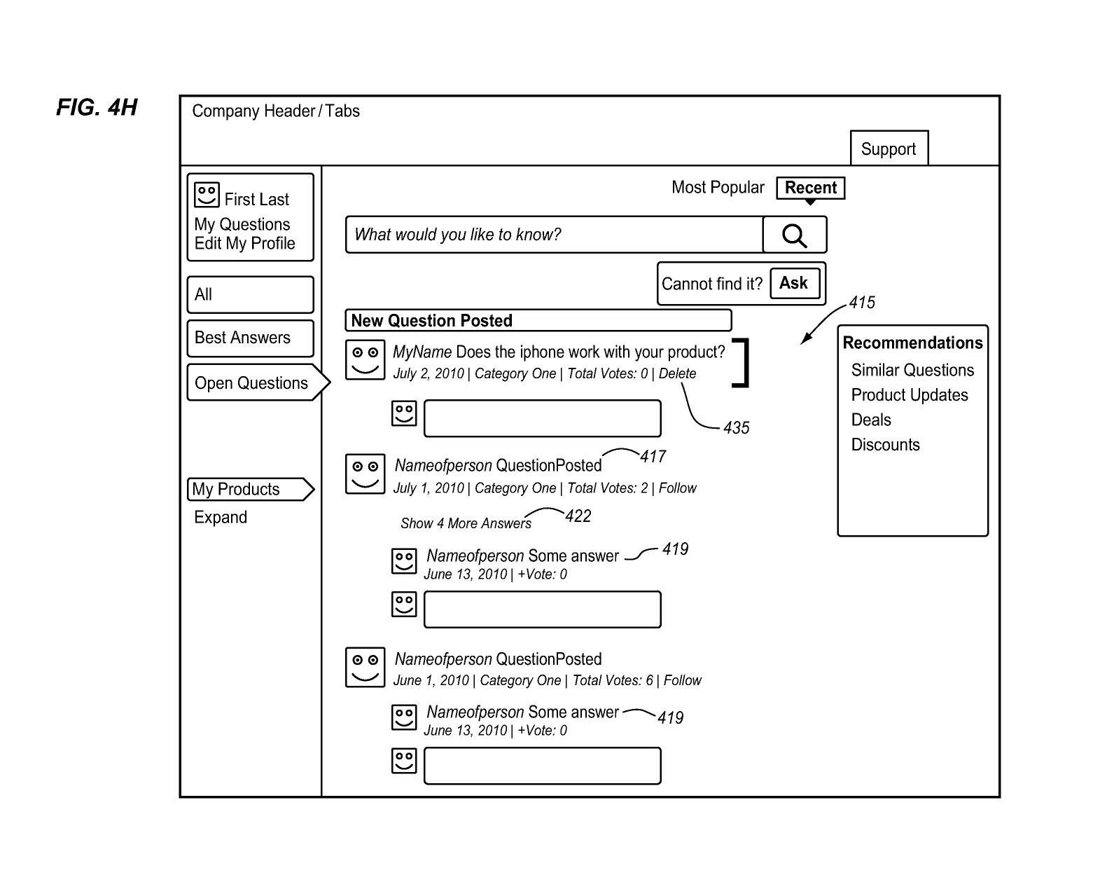

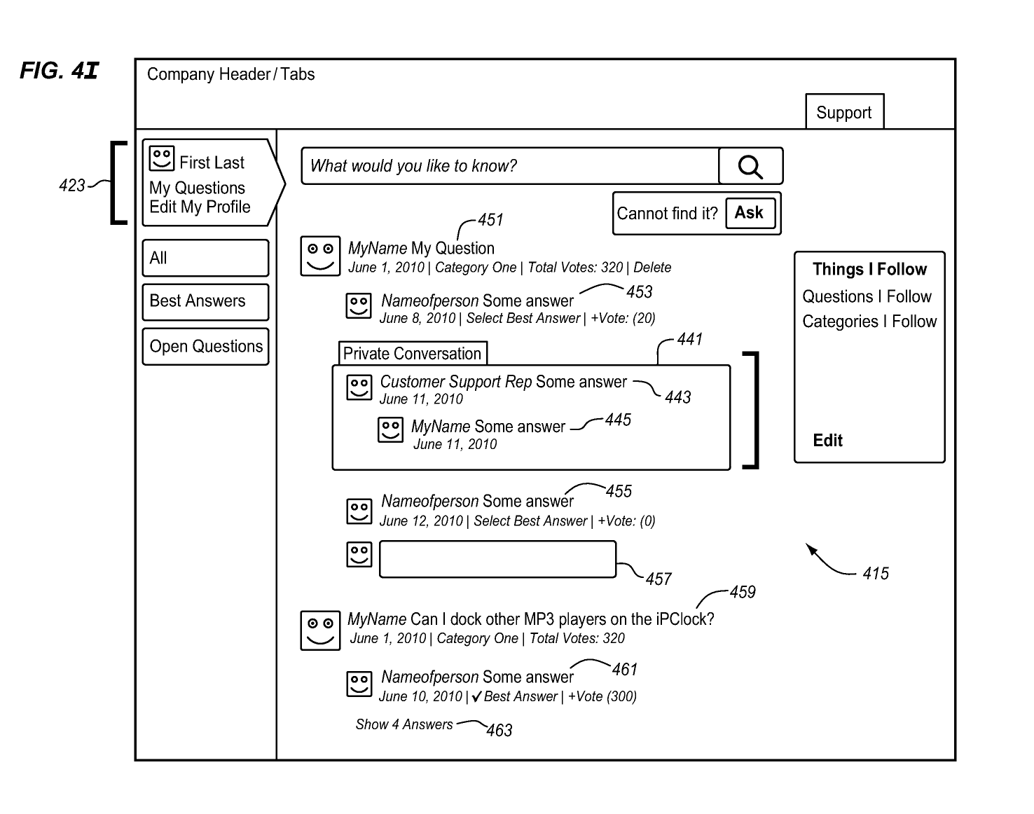

FIG. 4A provides a detailed view of a support landing page 401 such as that of FIG. 2A indicated as 223. There is a query box 403 on the support landing page 401 for a user to indicate a query and, upon entering a query, a search button 405 allows the user to use the query as a search term. An Ask button 407 allows the user to submit the query directly to company representatives or expert users, depending on the particular implementation. The illustrated example support landing page further provides a log in box 409 and category selectors 411. The category selectors allow the user to select to see all answers, the best answers, or open questions that have not been answered.

In one example, when the user first arrives at the support landing page shown in FIG. 4A, the best answers are already presented. This can allow a user to see answers to the most common questions, perhaps avoiding the need to even submit a query at all. A further category selector 413 can allow a user to select answers that apply to particular categories. In the illustrated example, all categories are shown and the best answers are shown. These can be default settings for an initial landing at the support page. The categories can relate to different kinds of problems. For example, a first category may relate to menu and use questions. A second category can relate to powering on questions. A third category can relate to battery and repair issues, etc.

In the display of best answers, a central area of the support landing page 401 can provide a separate central pane 415 for discussions to be posted. In the illustrated example, each question and its corresponding answer is shown with a date, an indication of the category to which it belongs, and a number of votes. The votes can be provided by the community or by users to indicate whether they like this question or dislike this question. Votes can also be applied to answers. Alternatively, the votes can indicate a number of times that the question has been asked or answered. In the illustrated example, there is a question of whether other music players can be docked on the iPClock, a fictitious name for a fictitious product used as an example herein (also referred to as the IPSpeaker).

The central pane shows several different questions 417 and answers 419. The questions and answers are shown next to each other and as indicated by the selection tab 411, the displayed answers have been voted to be the best answer or the most popular answer or the most frequent answer and is therefore shown as a best answer in the category selection area 411. The central discussion pane 415 also shows other possible responses to the questions. There can be references to support articles 421 and other similar questions or answers 417 and 419.

Referring to FIG. 4B the user can type a query in the query text box 403. In the present example, the user has typed in “does the iphone work with your product?” The user has then selected the search button and the results are shown in the discussion area or pane 415. In the answers selection tabs 411, “All” answers is selected and “All” categories 413 is also selected. This provides more results as shown in the discussion area 415. As an example, a further reference to support articles 421 asking “What mobile devices do you support” is shown. Additional questions are also shown 417A 417B.

In FIG. 4C, the user has logged in at the log in box 423. The user's name is displayed generally as “First Last.” The user's particular questions are shown and there is an opportunity to edit the profile associated with the log in. There is also a selection tab for “My Products” on the left-hand margin. This can be used to allow the user to edit his registered list of products and to look for specific advice that relates to a particular one of his products. Additional options may be provided depending on the particular implementation. The user has selected the best answers tab 411. As a result, the discussion area 415 shows only a few of the answers.

A display option 422 in the discussion area allows additional answers to be shown, if desired. This is an example of some possible display options, however other may be also or alternatively be provided depending on the particular circumstances. This user feature allows for a variety of different types of answers to be shown in the same discussion area or for a particular type of answer group to be expanded or contracted to show more or less detail.

A recommendations box 421 allows the user to also select similar questions, information about product updates, information about deals, and information about discounts. As an alternative to the discussion area 415 these options can be provided either by changing the discussion area or taking the user to a different page. Note that beginning with FIG. 4C the user has logged in and so the log in box has been replaced with a personal profile box 423 which shows the name of the logged in user and then personal option and choices. As a result of logging in, the discussion area of 415 shows more relevant data that relates to the user's question rather than generic questions. By selecting the “My Questions” option in the personal profile box 423, the user can manage which questions he would like to have answered. Questions can be deleted and new questions can be added.

Referring to FIG. 4D, an open questions category has been selected in the answers selector tabs 411. This selection is used to show generally any questions that are open for that user. The discussion area 415, accordingly, shows two different questions 417 that have previously been posted by the user and different answers 419 that have previously been offered by the community, company representative, or others who participate in the support system. As with some of the other figures, the page has an option to select either the most recent items 425 for any category or the most popular items 427. These options are provided both before and after the user has logged in as can be seen with reference to FIG. 4A. FIG. 4B shows a variation in which there is a tab for the most relevant answers. Such an option may be used when the user has entered a query. In FIGS. 3A and 4D, no query has been entered.

Referring to FIG. 4E, the user who has logged in has entered a question “does the iPhone work with your product?” This question in the text entry box 403 can then be supported in this case by selecting the ask button 407. In the display of FIG. 4E the best answers have been selected for display so these answers are answers that relate to the question but are not directly for that particular question.

In FIG. 4F the user is presented with similar questions to the question that was asked. A question drop-down list 427 is presented in response to the user selecting the ask button 407. The drop-down list presents similar questions. These questions are questions that have been presented and answered previously. The questions may be selected by a word matching algorithm a popularity rating or a combination of different techniques. By selecting one of the similar questions, the user can get an immediate answer to a question that has already been answered. If the user does not select one of these questions then the user may be delayed in receiving an answer to his particular question.

In FIG. 4G, an alternative drop-down list choice is presented. This alternative may be used instead of or in addition to the drop-down list of FIG. 4F. In this example, rather than selecting a question from the drop down list, the, the drop-down list 429 of this example asks the user to characterize the question. At a first level, the user is asked to select a category in a second drop down list 431. The user can also select, at 433, to make the question a private question to customer service. This allows the user to submit the question directly to a company representative and avoid submitting the question to the user community.

A final button in the main drop-down list 429 allows the user to “Click Continue to Ask and Post Your Question.” Upon making this selection, the question is submitted to company support and the user is presented with the view in FIG. 4H. Note that in FIG. 4G, the selected best answers are still displayed even as the user submits the question to company support.

In FIG. 4H, the user question has been posted to a customer service representative and that question is shown in the discussion area 415 as item 435. The discussion area also shows some answers 419 to similar questions 417 that have also been posted. Note that the user's private question 435 is posted at the top, keeping it the primary focus of the thread. At the same time, the other questions, answers, support articles and related items are still displayed but they are giving less prominence by being displayed below the private question.

FIG. 4I shows an example screen display that may be presented after the user has submitted the question and then returns sometime later. The user logs in at box 423 and, as shown in the discussion area 415, the user has received answers to a variety of these questions. As shown in the private conversation box 441, an answer 443 to the private question has been provided to the user. The user can then present a response to that question at 445 also in this discussion area.

In the example of FIG. 4I, the private conversation is highlighted by framing it. This is one example of highlighting the private conversation to keep it the primary focus of this user's thread. Other techniques may alternatively be used depending on the preferences for presenting the web site experience. The private conversation has also been raised above some of the other questions and answers in order to keep it prominent. In one example, the framed private conversation is treated as a unique block and is always open until the question is resolved. This can be done by the user indicating satisfaction or by company support providing an answer or by company support indicating that the matter is resolved.

The support system can strike different balances between emphasizing private conversations and supporting the community. As shown above, a user may post questions to either company support, the community or both. By allowing the community to stay involved, community support is fostered. By allowing the user to exclude the community, a direct, personal connection to official company information can be enjoyed. As shown above, the system can list questions and answers in different ways. They can be ranked, sorted, and categorized by popularity, relevance, date and other criteria. In addition, questions and answers can be folded with the “Show x Answers” link that is shown in several of the example displays (where x is the number of available answers). A similar option can be used to fold questions. The folding technique allows important questions to be maintained as prominent.

In one example, when an agent starts a private conversation, that conversation becomes the primary focus of the thread. To make that apparent to the end user, all of the other questions and answers can be folded automatically. This allows all of the previous and subsequent public answers to be folded under one or more links, such as a “Show x Questions” or “Show x Answers” link. Using folding, the private conversation can be raised to the top of the screen keeping it as the primary focus. A similar effect may be achieved by date sorting, color highlighting, using a separate area of the screen, etc.

In one example, the private block 441 moves through the entire conversation as one unique block, always open until the issue is resolved. In other words, while other conversations (question and answer cycles) can be folded and unfolded or moved or deleted, the private conversation cannot be. This also helps to show it as the most important aspect of the customer conversation. This approach communicates to the customer that company support and the company support web site takes private conversations and customer satisfaction seriously. It recognizes that when the customer decides to make a question private, then the question may be important to the customer.

At the same time, the present support system also allows community support to be encouraged. In the illustrated examples, this is done in part by encouraging users to submit questions to the community and then allowing users to rank and vote on the answers. The user is also presented with public answers at the same time that the private conversation is displayed. The public answers in the example of FIG. 4I comes after the last private conversation block answer. These public answers are made visible and positioned below the private block on the display. As s result, the user can continue to engage the community even as the private conversation is made the primary focus of the support experience.

These techniques can be seen by considering the example of FIG. 4I in more detail. The user's initial question 451, which was sent to the company representative, is located on top. The user in this hypothetical example is named “MyName.” There is an community answer 453 following the question and then the private conversation answer 443 in the private conversation box 441. The user has followed up the private answer, with a follow-up answer 445. This follow-up answer is also private. While the original question was not private, the rest of the conversation is. The private portion of the discussion is identified by being in the private conversation box. Again, the box as used as an example, any other way of designating the discussion may be used instead.

After the newest answer and the private answer, other users have also provided answers 455, 457. These answers are older so they are listed below the private answer. In the illustrated example, the answers are all in date order with the oldest answer first. However, they may be arranged so that only unviewed answers are above the private conversation box, or so that the newest answers are put at the top. Additional questions 459 and answers 461 may follow the first question 451. And these may be compressed in a variety of different ways using folding 463.

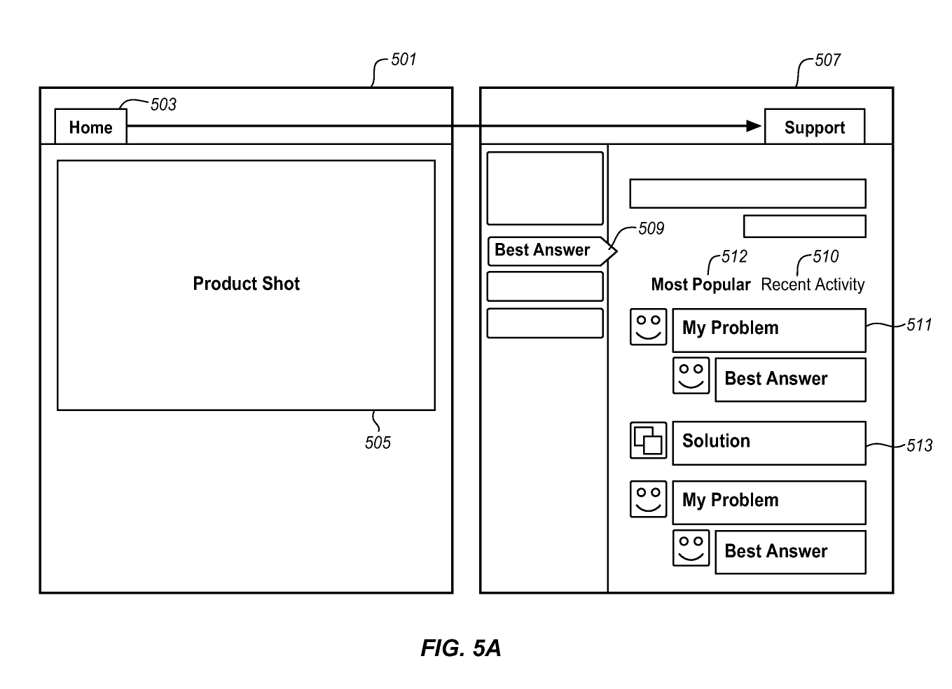

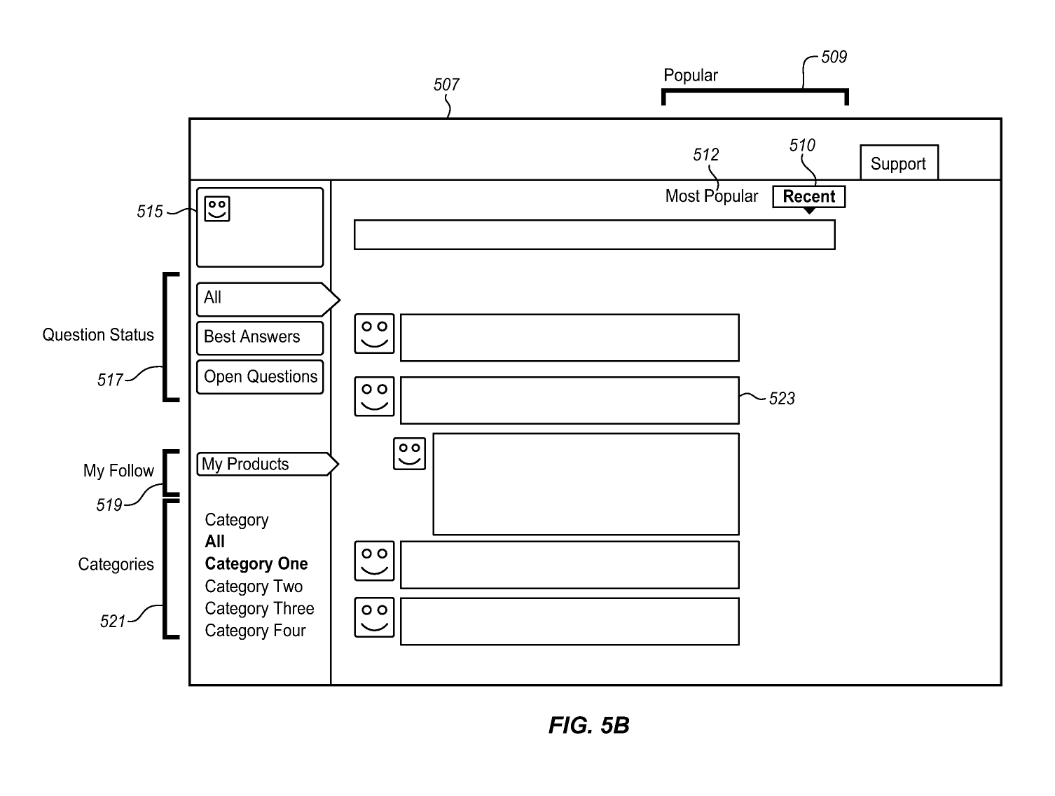

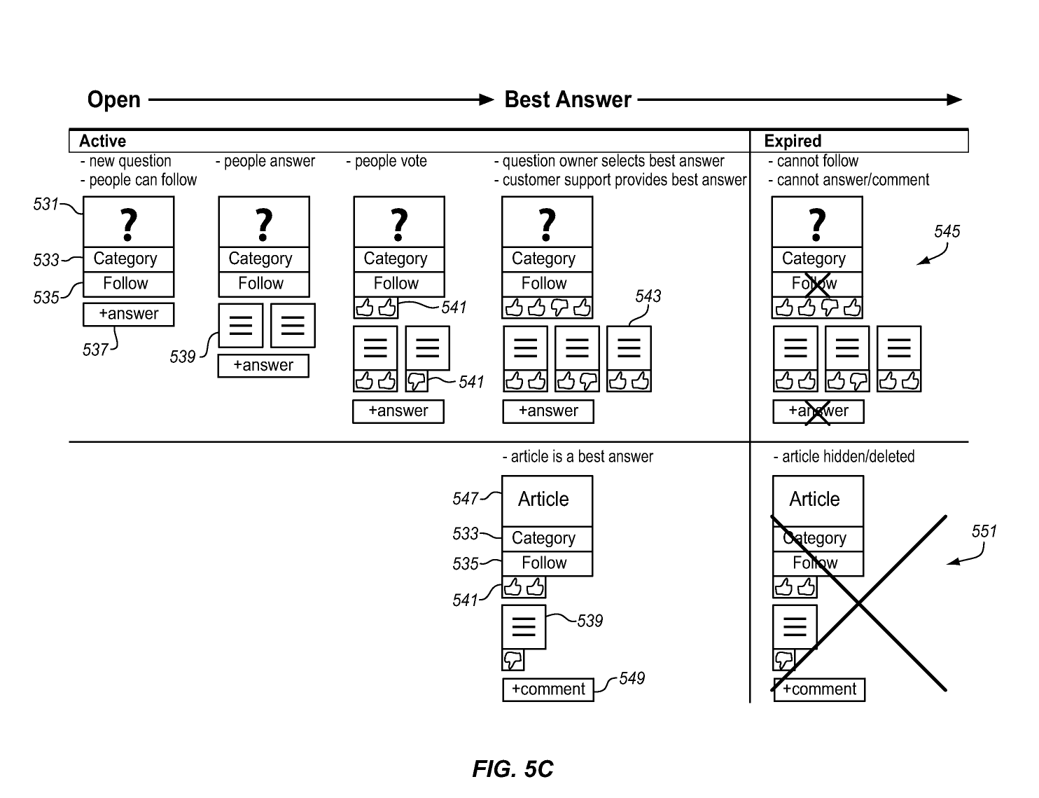

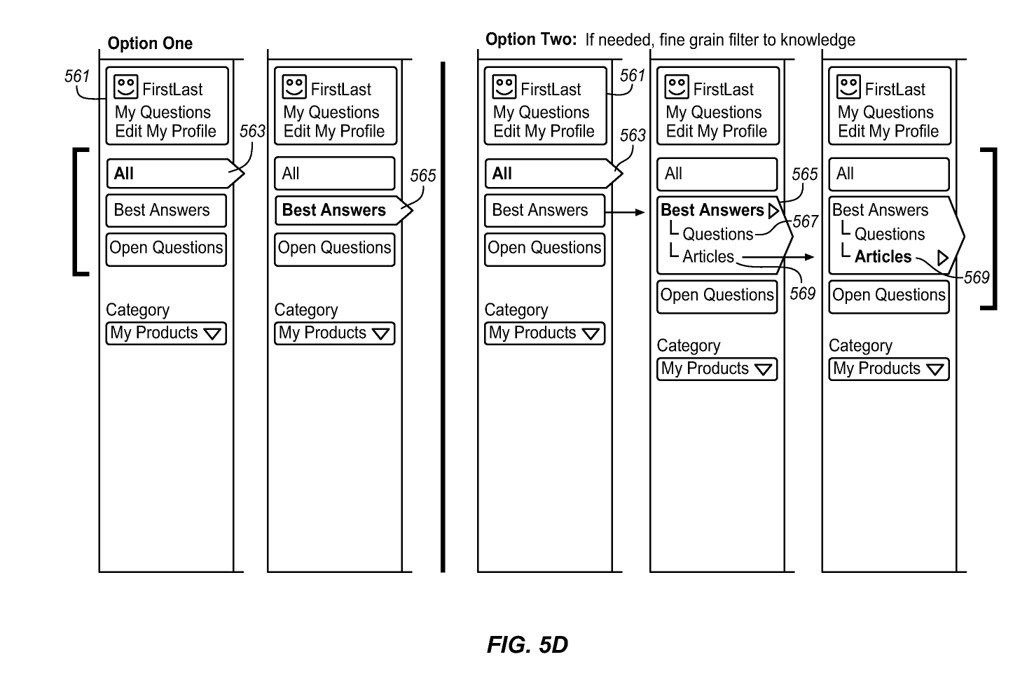

FIG. 5A shows a company website again as two sections. A first section 501 has a home page 503 and product pages 505 that present information imagery and other information about the company's products. The support page 507 can present a variety of questions and answers. In the illustrated example, the first view of the support page provides a set of answers to user questions and concerns. In the illustrated example, the best answers are automatically selected by default 509 and the most popular 512 and best 509 answers are presented. Questions can also be sorted in other way such as recentness 510. These answers can include answers to specific questions 511, and particular solutions 513 from white papers, user manuals, or knowledge-base articles. By presenting answers rather than problems, the user is provided with a more positive experience. In the illustrated example, only positive experiences from other users are displayed at the first landing into the support section 507 of the website.

FIG. 5B provides an overview of example items that can be displayed on a support page 507. In one example, an area 509 along the top of the page allows a user to select popular answers or popular questions based on recentness 510, for example when the question or answer was posted, or on popularity 512, for example how many views the question or answer has received. Other options may also be provided such as highest rated, favorites of the company's support representatives, etc. Along the left side of the page, there is a user log in area 515, a Question Status area 517, a My Follow area 519, and a Categories area 521.

In the Question Status area, the user can select, for example, all the questions, the best answers, open questions, or some other category. In the My Follow area, a user may focus on particular specific questions and answers that the user has either posted or selected as important. The Category section 521 allows the user to select between different categories or all categories. A central discussion area 523 shows the end results of all the category, status and follow selections as a set of question and answer postings.

FIG. 5C shows how a question can be filtered and processed using a filter system for a support site. On the left side of the diagram, a new question 531 is received and processed into the question filter system. The question is attached to a category 533 and a follow tag 535. The follow tag allows the question to be followed by other users or by company representatives. The question may also be associated with an answer 537 after sufficient time. The question may be processed with or without an answer. Some questions will immediately receive answers while other questions will not receive answers until some processing has occurred. Other question may never receive answers.

At the second level of processing, the question receives answers 539 from one or more sources, such as users, expert users, community members, company representatives, search results, etc. The question and the answers then receive votes 541. The votes may come from the same sources that are eligible to provide the answers and may come from guests or users that want to participate in the system or that have provided their own question and would like to contribute in another way. This voting may be applied to many different questions and to many different answers. Based on the voting, a best question may be selected. In addition, a best answer may be selected for the best question or for all of the questions.

At the next level of filtering, the company representative has provided an answer 543 for the question. This answer may be automatically selected as the best answer or the answer can be selected based on the votes or based on the opinion of the user who originally posted the question. Even when a best answer is selected, other answers may be shown with the associated number of votes. This allows later users to see a variety of different answers and select the one that is best suited to their particular circumstances.

After some time, a question can be configured to expire. At area 545, a former question and best answer has been moved into a retirement status. As indicated, the question cannot be followed and the answer cannot be accessed or displayed to users.

A similar approach can be applied to articles. The articles, as mentioned above can come from a knowledge base, whitepapers, user manuals and guides, or any other source. As shown, an article 547 can be associated with a category 533, and can be tagged for following 535. The article can also receive votes 541. The article can be associated with an answer 539 which can also be voted on. In contrast to questions and answers, the article can be exposed to comments 549 from users, experts, or company representatives.

Comments can also be applied to questions and answers to provide more detail about particular answers. The article may be treated as a best answer or as a separate and different kind of item. By treating articles in the same way that questions and answers are treated, articles can be incorporated into the same display and provided to users without leaving the user interface for questions and answers. In area 551, the article has been expired and, like the expired question, it can no longer be followed or viewed. The article is effectively hidden or deleted.

Referring to FIG. 5D, two different approaches are shown for showing the best answers to a question. In the first option on the left, a user has logged in as shown in a log in box 561. The default question status field is for all answers 563. The user then selects the best answer's question status 565 and the best answers are displayed. In this example, answers and articles are shown together. In the second option, the user logs in and is shown all answers 563. The user then selects, best answers 565 and is presented with a choice to filter the answers. The user can use questions 567 or articles 569. Other choices may also be presented, depending on the particular implementation. Depending on the choice, only the one or the other will be presented to the user. This allows the user to have the kind of answer that he desires.

Referring to FIG. 5E, categories of answers can also be filtered. For a guest user that is not logged in to the log-in panel 561, as shown at the left, a category selection 571 can be used to select one or more different categories. In the illustrated example, there are four categories that are shown when the guest user triggers a drop down list. Alternatively, all of the categories can be selected.

For a logged in user, by contrast, a different option can be used. In the illustrated example a “My Products” selection 573 is provided. The guest user may expand the My Products list to show different categories of products. In another embodiment, the My Products selection can be expanded to show different products that the logged in user has registered with the company website. The products may be grouped into categories 575 or shown individually, depending on the particular needs of the user.

As shown and described above, a variety of different ideas may be used to filter answers and views to provide the best user experience. In determining which answers are the best answers and in selecting rankings or votes for answers, many different techniques may be used. In one example, page views are used. The answer that is most frequently viewed is selected to be the best answer. In another example, an answer that has a large number of followers, comments or votes can be selected. In another example, a multiplier is used to weight these different measures. So, for example, follows may be weighted to count half as much as votes, so that both are considered but indirect factors are treated as less important than direct factors. In another example, the company can decide which is the most important and the influence of user group and community factors can be alerted to the company for the company to evaluate. This allows a company to take a direct or indirect hand over the website support information depending on the particular circumstances of the company and the desired support experience.

The support pages can be further tailored to particular product areas by creating different appearances and user experiences for different categories of products. In one example, consumer entertainment products can provide a more casual, and suggestive support experience, while network infrastructure products can provide a more detailed, factual, technically precise experience. In another example, users who login with dealer or reseller credentials can be provided with a different experience than end user or purchaser groups. The experience can also be customized by tailoring open groups in a way to promote participation. Private questions can be more oriented toward resolving questions quickly and cordially. The filtering processes described above can also be applied differently for different product categories and different groups.

The support page system can be further enhanced in a variety of other ways not fully shown in the diagrams herein. These enhancements may be adapted to promote a range of different product, marketing, support, and sales strategies. In one example, a recommendation engine can be used to direct different users to different support landing pages. Information about the user can be obtained from a login, from cookies, from the user's browser, or from direct questions to determine which landing page is best suited for any particular user. In another example, user credentials can be taken from another web account, such as Facebook, Twitter, or other accounts. A user can also be directed to the support pages directly from another user account. So, for example, a user may visit a company's Facebook page and then enter the support pages of the company website directly. The user's Facebook credentials might then be used to log the user in, rather than using a separate support page login.

In the examples above, questions can be followed by other users of the support pages. This can be provided using a separate follow interface area in which users can see outstanding questions and answered questions for a particular product or category of products and then choose to follow that question, the question can be associated with that user identification. When the user logs in, the followed questions can be retrieved and a recent status can be provided. The user can then stop following the question, post comments, or more. In another example, a user might be offered an opportunity to have a question automatically selected for following. The question might be selected as relating to a particular product, category, set of words in the question, etc. For more active following, push notifications, e-mails, or other notices can be sent to a user when there is activity on a question that the user is following.

In order to motivate users in the community to participate in the support system, incentives may also be provided. The company can monitor user answers and, based on votes, rankings, page views, or any other factors, select particular users for recognition. Users may be recognized by a special status in a user name, access privileges, leader indications or direct rewards. By encouraging hobbyists to participate more fully, the demand on company resources may be reduced and the company may be able to provide better support at less cost.

The support system described above presents a variety of different advantages to different kinds of users. An active and knowledgeable user can become a known expert, recognized by peers. This status may be sufficient reward or may be used to promote an independent repair or sales business. For purchasers and users, the support site can provide more support than a company may be willing or able to provide. A user may also be able to find additional solutions that a company cannot endorse. Using the private features, a user can receive help with personalized or private issues. For example, the private option can be used to resolve billing issues. Public questions allow all to view the question. These features can be used to allow a newly arriving user to immediately learn of widespread problems, such as service outages, calendar based bugs, etc. With a public view, it will be clear to a user upon landing on the support site that others are having a similar issue and that it is a common or widespread issue.

Additional techniques may be applied to further optimize a support page using the principles discussed above. In one example, company representatives can be designated for particular groups. This may allow the representative to create a personality both in answering and in presentation for particular categories of goods, issues, or user groups. Similarly for dealers, resellers, technicians, service organizations, installers, and others, the company can use log in credentials to allow extended support information to be provided. Dedicated company representatives or access to more expert company representatives can be provided as needed or desired.

In further refinements, a variety of different default or selectable configurations and operations may be provided. So, for example, open groups can be made visible to all users. Users that have not logged in can be provided with a guest access and allowed to see all open groups and questions. For authenticated users that have provided a profile, they may automatically be shown open groups and questions based on their product choices. The product choices may be purchased products or products in which the user has a strong interest.

Looking back at the different functions and utilities shown in the drawing figures and, in particular, the sequence of example user interface screens in FIGS. 4A to 4H, there has been shown an example embodiment of a customer support system. For example, the system may begin with asking a user to register or login to a support website. Assuming the user registers, the user can then post a question to the online community. The figures also show instances in which a user does not register but still posts a question. Without registering the user can also view questions and answers that were posted by others. As illustrated, the online community can include both customer support representatives from the website company and other users of the website company's products. In addition, the user may be prompted with various questions and choices as he inputs a question to facilitate the search.

The customer support system may show a screen that allows the user to either narrow down their search or alternatively post it directly as a private message to the customer support representatives of the company. The user may then be provided with the ability to click on “My Questions” to show only those questions posted by the user. Responses to these may be obtained from a user of the online community and the original poster can post a response. Such a back and forth may continue until both sides are satisfied.

The customer support system may also be adapted to display on different types of devices. Questions, answers, and other posts may be viewed from a mobile device, a desktop device, or even a properly configured television. In one implementation, the user can access the customer support feed via a mobile device. Similarly, a user may respond from the mobile device.

The customer support system in the described examples can also support private posts by a customer support representative. In one example, the user is able to select to view all the answers. In another view, the first four answers may be hidden, but selectable by a “Show 4 Answers” or “Show More Answers” control. With private posts, other users typically cannot see the post. In one implementation, the original user may select other users to grant permission to see and comment on that user's private posts. The same system may allow the user to respond to the private messages. Again, the post may be only accessible to the customer support representative and the user.

At the same time, if a user group or community is a part of the customer support system, then other users may continue to post about the posted question even as the customer support representative is having a private conversation with the user.

The customer support system described herein also offers display options to allow the user to configure and manage all of the conversation and posts. In one embodiment, the private conversation may be moved to the bottom or the top of the queue as displayed in the user interface. In one embodiment, the private messages in the conversation may be grouped together. In addition groups of questions may be compressed or expanded on the display.

Typically, there will eventually come a final post by a support community member, super user or a customer support representative indicating the problem was solved. In this case, the many posted answers may prove to be confusing or even misleading. The customer support system solves this problem by ranking the answers and even selecting a best answer. In one implementation, either the user, the customer support representative, other users, or some combination select the best answer from among all of the answers that were posted for a single problem or group of problems. In one embodiment, the best answer is put at the top of the conversation. In another embodiment, the best answer may be added as an answer to frequently asked questions.

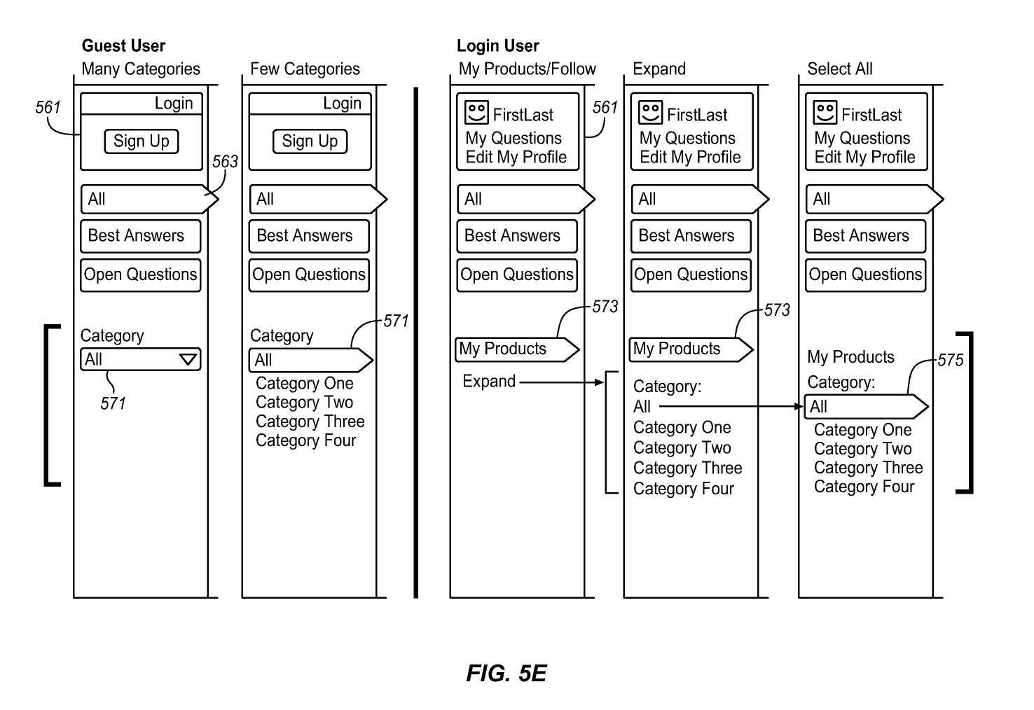

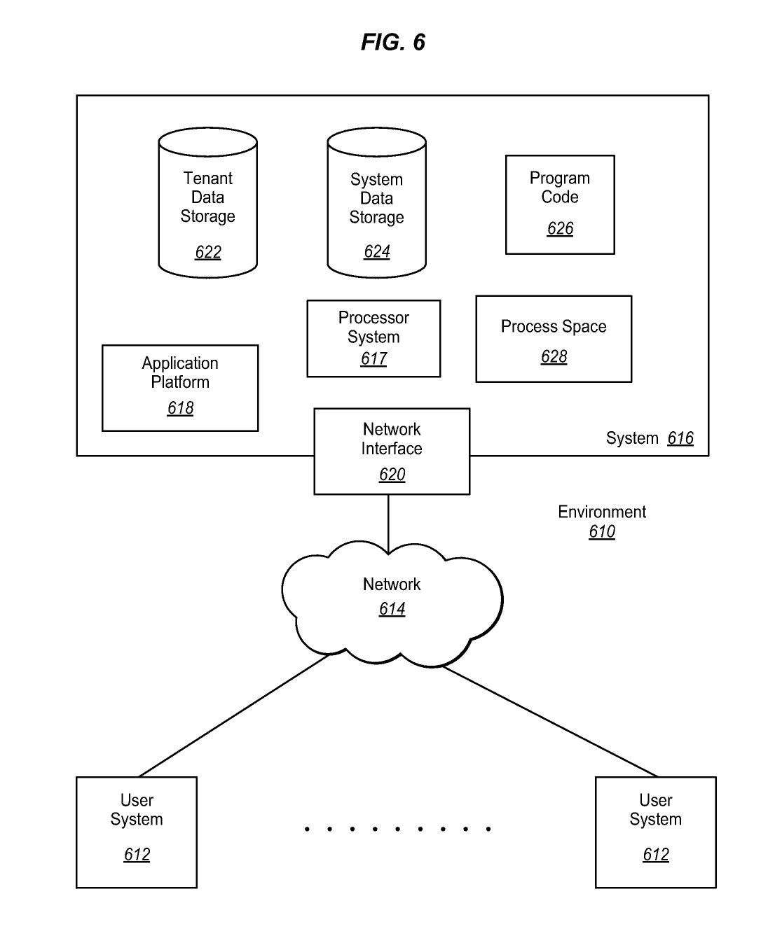

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

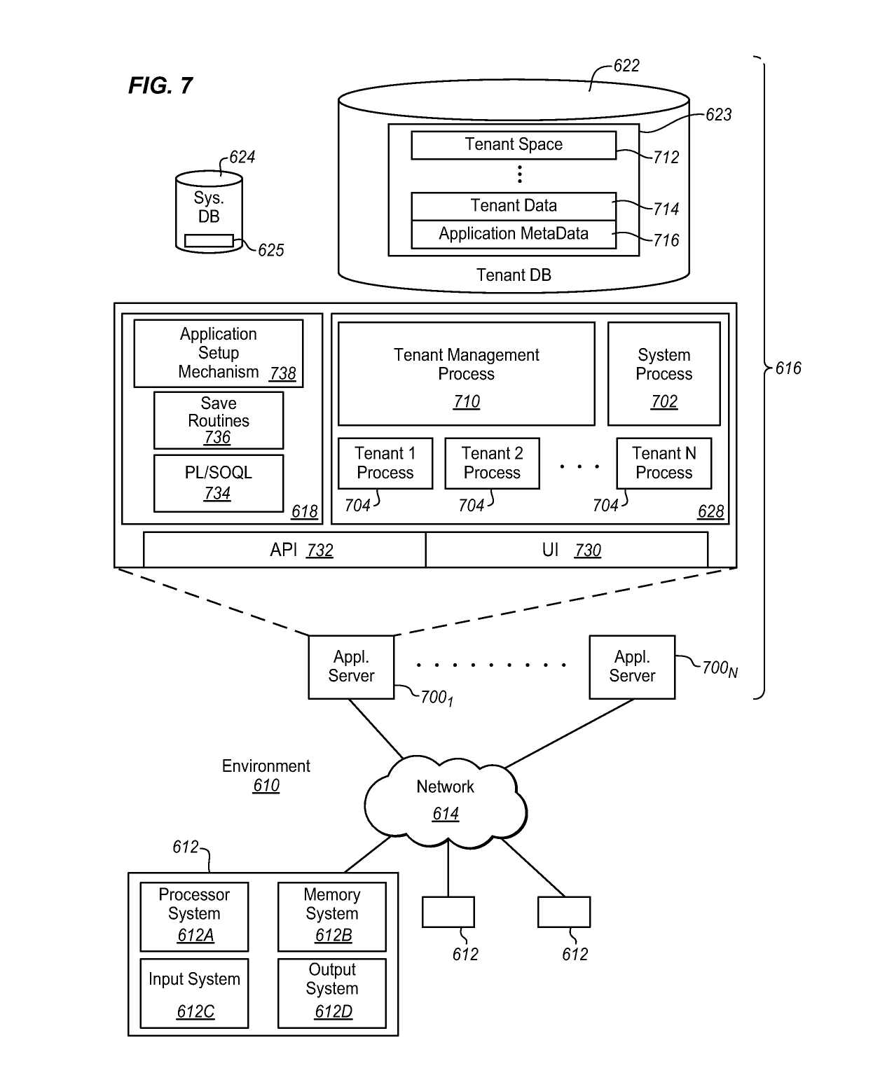

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 7001-700N, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT DATABASE ON-DEMAND DATABASE SERVICE issued Jun. 1, 2010 to Craig Weissman, which is incorporated in its entirety herein for all purposes. Invocations to applications may be detected by one or more system processes, which manages retrieving application metadata 716 for the subscriber making the invocation and executing the metadata as an application in a virtual machine.

Each application server 700 may be communicably coupled to database systems, e.g., having access to system data 625 and tenant data 623, via a different network connection.

For example, one application server 7001 might be coupled via the network 614 (e.g., the Internet), another application server 700N-1 might be coupled via a direct network link, and another application server 700N might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

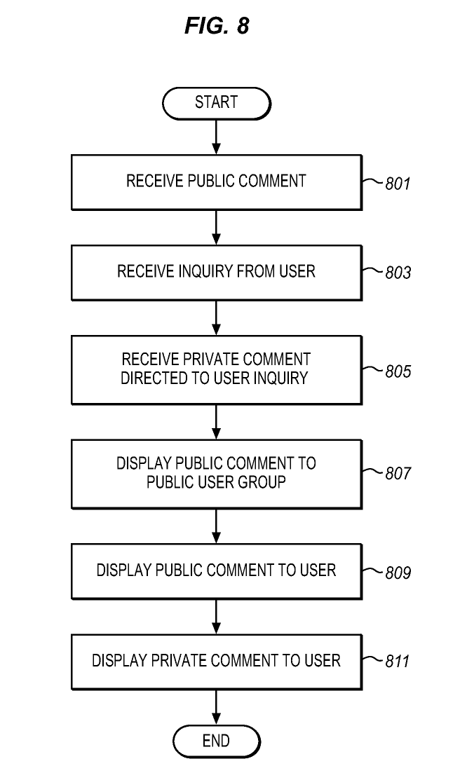

FIG. 8 is a process flow diagram indicating some of the operations that may be used to implement a customer support system as described above. At 801, a public comment is received. In the examples above, the public comment is received at a customer support system. As explained in the above example, the customer support system may be supported by a variety of different participants in the chain from manufacture to customer. The customer support system may be supported by one or more servers hosted by the manufacturer, another participant in the supply chain or by a third party.

At 803, an inquiry is received from a user. The inquiry can be about a product or service and may relate to features of the product, a problem with the product, or future developments of the product. The inquiry may also be about accessories, purchases, or compatibility with other products or services, depending on the particular product or service involved.

At 805, a private comment directed to the user inquiry is received at the customer support system. While these comments are illustrated as coming from a customer support representative of the sales, manufacturing or distribution company, other people may be authorized to provide private comments as well. In many cases, the private comments will be an answer to the inquiry or a request for further information about the inquiry.

At 807, the public comment is displayed to a public user group. The user group may require authentication of some kind or the information may be made available to anyone willing to log on.

At 809, the public comment is displayed to the user. This may be done in the same way that it is displayed to the public user group or separately. At 811, the private comment is displayed to the user. To preserve the privacy of the user inquiry and response, these are viewable only to the user. The user may be provided an option to make the inquiry and the private comment private or only the private comment. Allowing the inquiry to be public may allow the user to obtain answers that view the public inquiry in addition to the private comment. Public and private comments may be provided on different displays or at different times or together, depending on the particular implementation.

The displays will typically be provided as a browser web page display through the internet, however, they may be provided over other communication networks and using other viewing applications. A purpose-built or a general purpose feed reader may be used for example. A specific application or a general viewer may be used. In addition, as shown in the examples above, there may be additional operations and the order of the operations may be changed. So, for example, public comments may be displayed to a user before an inquiry is received or before a private comment is received. The private comment may be displayed to the user before the user inquiry is displayed to a public user group. Access to the private comment can be limited by authentication, such as a log in or in a variety of other ways.

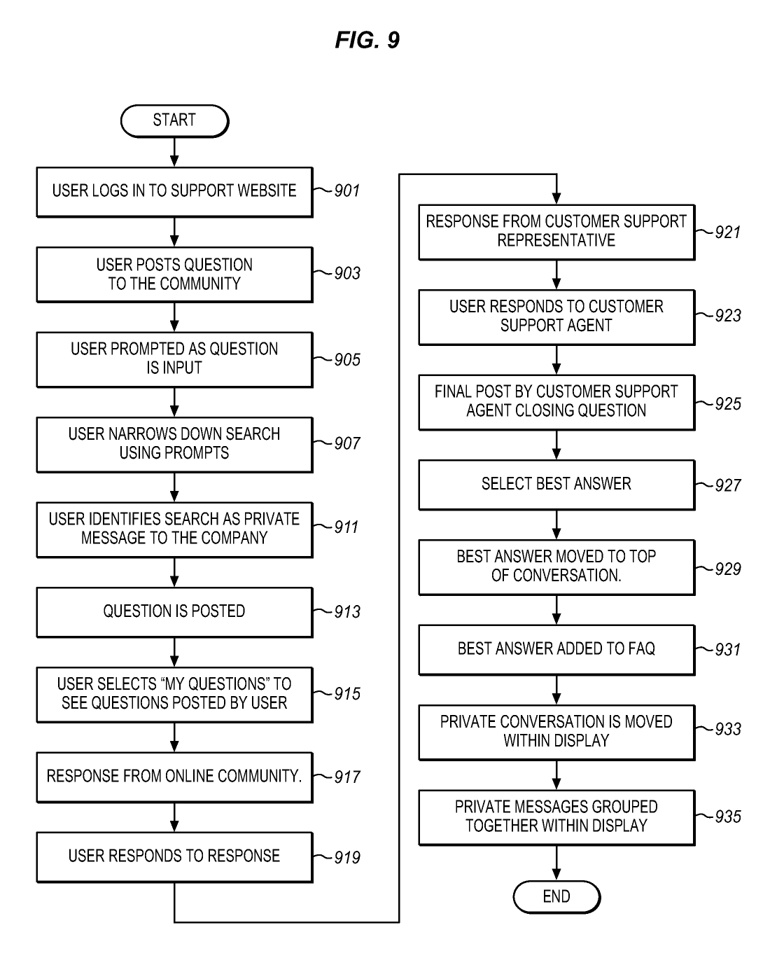

FIG. 9 shows a similar process flow in greater detail. As with FIG. 8, operations may be added or deleted to suit particular circumstances and the order of operations may be modified as well. At 901, a user registers with the support website. If the user is already registered, then the user logs in. The user can then be authenticated for this and later visits.

At 903, the user can then post a question to the online community. As an alternative, the user may instead simply view questions or answers that have already been posted either by himself or others. In one example, the user may be provided 905 with a prompt as he inputs a question. The prompts will be intended typically to facilitate the search for an answer. In one example, the prompts are proposed questions that resemble what the user has entered. These questions may have the benefit of being better phrased or having already been answered. The prompts may also allow the user to narrow the inquiry to certain products or types of products or to certain areas of inquiry, such as maintenance, warranty service, repair, use, etc.

At 907, the user narrows down the search using the prompts and, at 911, the user narrows the types of people that are permitted to view the question. This can be done using a prompt to designate the search as either a private message or a public message. A private message will be sent to the customer support representatives of the company. At 913, the user posts the question.

The customer support system can provide many different tools for viewing and managing questions, queries, answers and comments. At 915, the user clicks on “My Questions” to show only those questions posted by the user. This can be done in the same session as the original log in at 901 or it can be done at a new session at a later time.

At 917, there is a response to the user's question from a user of the online community. The response may be displayed with the query and the display may be public. The community response may be generated in any of a variety of different ways. In one example, the question is posted on page with other questions and it may be supplied in feeds to community members. The community members log in to the support page or view the feed and then post responses. The response may be applied to a discussion group where the post is commented on by community members. The community may be restricted to those with log in credentials or it may be open, depending on the particular implementation.

At 919, the original poster of the question may respond to the response. There may then be follow-up communications from one or more members of the community. The postings may continue as long as there is interest from the user or members of the community.

At 921, the user receives a response from a customer support representative. This response may be viewed in any of the same ways that the community response is viewed. If this part of the support has been designated as private, then this response will be seen only by the user. As mentioned above, a user may choose to receive only responses from the community or only responses from customer support, or both. The user may designate the question to company support as public or private and may designate responses and later communications with company support as public or private. In the illustrated examples, the post is a private post by the customer support representative. The original user, however, may select other individual users or user groups to grant permission to see and comment on private posts.

At 923 the user posts a response to the customer support agent. As with the community, the user and representative may continue to post until the matter is closed. At 925, a final post is made by the customer support representative indicating the problem was solved. This closes the matter. At the same time, other users may continue to post responses with the user and with other community members even though the customer support representative is having a private conversation with the user.

At 927, the best answer may be selected as a response to the user's initial question. The selection may be made by the user, the customer support representative, other users, or some combination of these persons or groups. This best answer designation, while not required, may make it easier for a later user to find a good answer to a similar or the same question. Later users may be further helped at block 931 if the best answer is added as an answer to a frequently asked questions (FAQ). The control and maintenance of the FAQ may typically be by company support, however, it may also be controlled by others or there may be multiple FAQ's on the same support site managed by different people.

FIG. 9 also shows a variety of different ways that views may be managed and adjusted. These changes may be made to particular user's view or to a generic public or community view. In one example, at 929, a best answer may be put at the top of the conversation. It may also be moved to some other prominent position depending on the particular layout of the support system. At 933, the private conversation is moved to the bottom of the queue or to some other location within the display. At 935, the private messages in the conversation are grouped together. Many other changes to the display may also or alternatively be made depending on the particular circumstances.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method comprising:
receiving a public comment;
receiving an inquiry from a user;
receiving a private comment directed to the user inquiry;
displaying the public comment to a public user group; and
displaying the public comment and the private comment to the user, wherein the private comment is viewable only by the user.

2. The method of claim 1, further comprising receiving an authentication from the user before displaying the private comment of the user.

3. The method of claim 1, wherein the user posts the inquiry to the public user group and wherein the received public comment is directed to the user inquiry.

4. The method of claim 3, wherein the public comment is from the public user group.

5. The method of claim 1, wherein receiving an inquiry further comprises presenting the user with alternative inquiries for the user to select.

6. The method of claim 1, further comprising receiving from the user an identification of the inquiry as private.

7. The method of claim 6, further comprising receiving from the user an indication that the private inquiry is to be sent only to a company support representative.

8. The method of claim 7, wherein the private comment is received from the company support representative.

9. The method of claim 1, further comprising receiving in indication that one of either the private comment or the public comment is best and identifying the best comment as such for other users.

10. A method comprising:
receiving an inquiry from a user;
forwarding the inquiry to a public user group;
forwarding the inquiry to a customer support agent;
applying the inquiry to previously received comments;
receiving a comment to the inquiry from at least one of the public user group, the customer support agent, and the applying of the inquiry; and
displaying the received comments to the user on a single display.

11. The method of claim 10, wherein receiving an inquiry further comprises presenting the user with alternative inquiries for the user to select and the inquiry is one of the presented alternative inquiries.

12. The method of claim 11, wherein the alternative inquiries correspond to previously received comments.

13. The method of claim 10, further comprising receiving an authentication from the user before displaying a received comment from the customer support agent.

14. A machine-readable medium carrying one or more sequences of instructions for customer support, which instructions, when executed by one or more processors, cause the one or more processors to carry out the steps of:
receiving a public comment;
receiving an inquiry from a user;
receiving a private comment directed to the user inquiry;
displaying the public comment to a public user group; and
displaying the public comment and the private comment to the user, wherein the private comment is viewable only by the user.

15. The machine-readable medium of claim 14, wherein the user inquiry is an inquiry posted to the public user group and wherein the received public comment is directed to the user inquiry.

16. The machine-readable medium of claim 14 further comprising instructions for:
receiving from the user an identification of the inquiry as private; and
receiving from the user an indication that the private inquiry is to be sent only to a company support representative; and
wherein the instructions for receiving a private comment include instructions for receiving the private comment from the company support representative.

17. An apparatus for customer support, the apparatus comprising:
a processor; and
one or more stored sequences of instructions which, when executed by the processor, cause the processor to carry out the steps of:
receiving an inquiry from a user;
forwarding the inquiry to a public user group;
forwarding the inquiry to a customer support agent;
applying the inquiry to previously received comments;
receiving a comment to the inquiry from at least one of the public user group, the customer support agent, and the applying of the inquiry; and
displaying the received comments to the user on a single display.

18. The apparatus of claim 17, wherein receiving an inquiry further comprises presenting the user with alternative inquiries for the user to select and the inquiry is one of the presented alternative inquiries.

19. The apparatus of claim 18, wherein the alternative inquiries correspond to previously received comments.

20. The apparatus of claim 17, further comprising receiving an authentication from the user before displaying a received comment from the customer support agent.
